(19) United States
(12) Patent Application Publication
(10) Pub. No.: US 2020/0173339 A1
(43) Pub. Date: Jun. 4, 2020

(54) Axial Flux Motor Water Pump

(71) Applicant: GATES CORPORATION, Denver, CO (US)

(72) Inventors: Vigel Russalian, Macomb, MI (US); Stephen Matthew Reaburn, LaSalle (CA); George Spehar, Clarkston, MI (US); Michael Cox, Tecumseh (CA)

(21) Appl. No.: 16/208,885

(22) Filed: Dec. 4, 2018

(51) Int. Cl. F01P 5/12; F04D 13/06; F04D 1/00; F04D 15/00; F04D 29/42; H02K 21/24; H02K 1/27; H02K 1/14

(52) U.S. Cl. CPC F01P 5/12; F04D 13/0693; F04D 1/00; F04D 15/0066; F04D 29/049; H02K 21/24; H02K 1/2793; H02K 1/14; F04D 29/4293

(57) ABSTRACT

An axial flux motor water pump comprising a housing, a cover attached to the housing, a stator mounted within the housing, the stator comprising a plurality of stator poles mounted in a ring, each stator pole comprising an electric wire winding, a rotor journalled to the housing in cooperating relation to the stator on a single bearing, an impeller fixed to an end of the rotor, a plurality of magnets mounted to an end of the rotor in cooperative relation to the stator poles, a seal between the rotor and housing whereby the stator and magnets are in a dry zone, the stator enrobed in thermal potting within the housing; and power electronics contained in the cover.

### FIELD OF THE INVENTION

The invention relates to an axial flux motor water pump, and more particularly, to an axial flux motor water pump comprising a mechanical seal.

### BACKGROUND OF THE INVENTION

The invention relates to a water pump for pumping a fluid, in particular a cooling liquid in an internal combustion engine or other application requiring a cooling fluid circulating pump. Axial flux motors for use with water pumps are known from the related art. In an axial flux motor, the magnetic flux lines extend in the air gap of the motor in an axial direction. The stators typically comprise round wire windings.

Representative of the art is U.S. patent application 2015/0030479 which discloses a wet rotor pump with an axial flux motor that includes a stator and a rotor. The stator is arranged in a dry zone while the rotor on an impeller is arranged in a wet zone. The rotor is formed by one or more samarium cobalt (SmCo) permanent magnets.

Representative art further includes U.S. patent application 2017/0016449 which discloses a pump comprising a housing partially defining a cavity, an impeller arranged in cavity, the impeller including a first disk, and a vane arranged on the first disk, the impeller operative to rotate about a rotational axis, a first stator core arranged on the housing, windings arranged on the first stator core, and a first inlet defined by the housing, wherein the first inlet, the impeller, and the housing partially define a fluid flow path.

What is needed is an axial flux motor water pump comprising a mechanical seal and thermal potting about the stator. The present invention meets this need.

### SUMMARY OF THE INVENTION

The primary aspect of the invention is to provide an axial flux motor water pump comprising a mechanical seal and thermal potting about the stator.

Other aspects of the invention will be pointed out or made obvious by the following description of the invention and the accompanying drawings.

The invention comprises an axial flux motor water pump comprising a housing, a cover attached to the housing, a stator mounted within the housing, the stator comprising a plurality of stator poles mounted in a ring, each stator pole comprising an electric wire winding, a rotor journalled to the housing in cooperating relation to the stator on a single bearing, an impeller fixed to an end of the rotor, a plurality of magnets mounted to an end of the rotor in cooperative relation to the stator poles, a seal between the rotor and housing whereby the stator and magnets are in a dry zone, the stator enrobed in thermal potting within the housing; and power electronics contained in the cover.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a cross-section A-A of the pump from FIG. 2.

FIG. 2 is a plan view of the pump.

FIG. 3 is a plan view of the pump.

FIG. 4 is a schematic coolant system.

FIG. 5 is an exploded view.

FIG. 6 is a perspective of the rotor magnets and frame.

### DETAILED DESCRIPTION OF THE PREFERRED EMBODIMENT

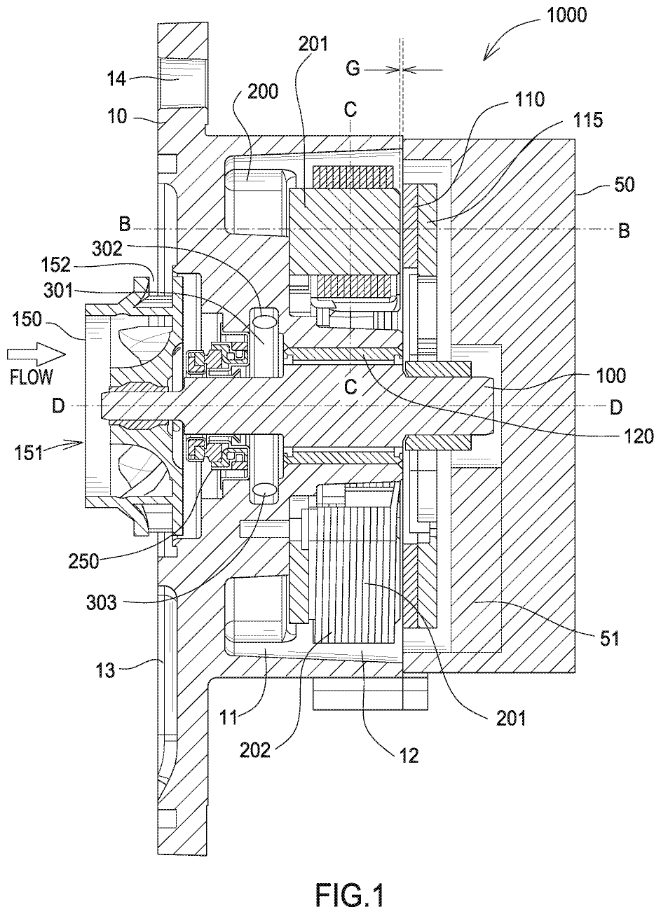

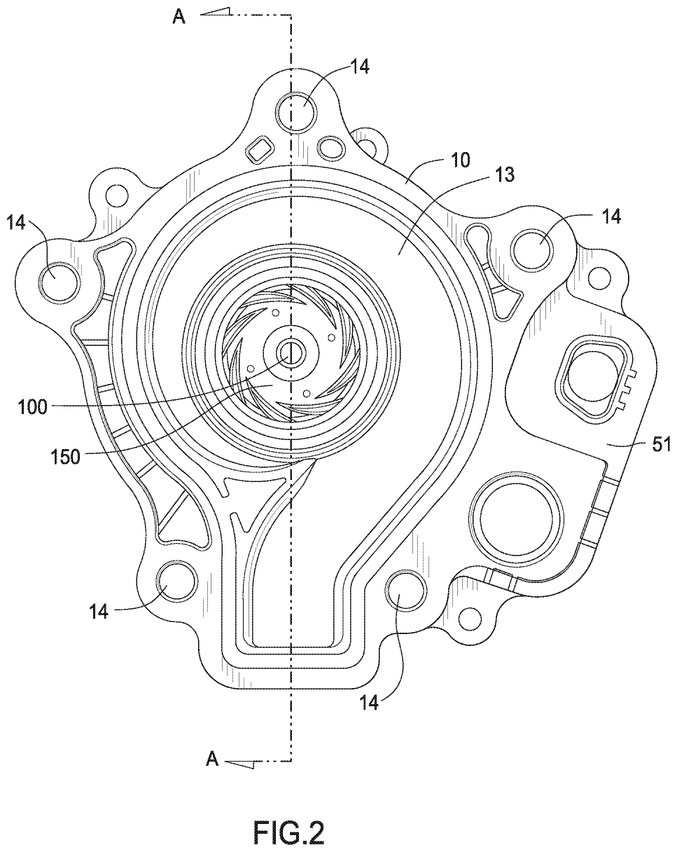

FIG. 1 is a cross-section A-A of the pump from FIG. 2. The water pump comprises an electric motor which drives an impeller. The electric motor comprises an axial flux motor. In an axial flux motor, the magnetic flux extends in the air gap of the motor in the axial direction due to the orientation of the poles and stator windings. The inventive water pump is typically used in an engine cooling system. The water pump pressurizes and circulates coolant through the engine cooling system.

Water pump 1000 comprises a housing 10 and cover 50. Impeller 150 is attached to an end of rotor shaft 100. A stator 200 is disposed within the housing. A plurality of stator poles 201 are disposed in a ring within inner portion 11 of housing 10. As is the case for an axial flux motor, axis B-B of each pole 201 is parallel to the rotational axis D-D of shaft 100. The motor comprises a three phase nine coil architecture. Stator poles 201 comprise a soft metal composite. Magnetic materials may be used for stator poles 201 as well.

Electrical wire windings 202 are wound around each pole 201. Windings 202 may comprise either flat wire or round wire in cross-section. The flat wire may have a square or rectangular cross section. The flat wire or round wire may comprise copper or aluminum. A winding plane C-C of windings 202 extends normal to shaft axis D-D so the magnetic flux extends in the axial direction, parallel to axis D-D. The inventive motor has a power rating of 200 W and up to 12 kW.

A plurality of permanent magnets 110 are mounted to another end of shaft 100 on frame 115. Magnets 110 may also comprise a single ring magnet with multiple poles. Frame 115 is fixed to an end of shaft 100 and thereby rotates with shaft 100. Magnets 110 are radially aligned with poles 201. An air gap “G” is maintained between poles 201 and magnets 110 thereby preventing contact between them during operation. The air gap is in the range of 0.2 mm to 1.5 mm. Gap “G” is preferably as small as possible in order to realize maximum magnetic efficiency.

Mechanical seal 250 prevents pressurized liquid coolant from entering the inner portion 11 and thereby coming in contact with the stator 200 and rotor magnets 110, hence, stator 200 and magnets 110 are in a dry zone. The dry zone is typically at ambient atmospheric pressure. Seal 250 is disposed between shaft 100 and housing 10. Seal 250 may comprise any suitable mechanical seal known in the art such as a bellows, cartridge, balanced cartridge and O-ring, unbalanced cartridge and O-ring, pusher and conventional type seals. Maintaining a dry space for stator and magnets increases the efficiency of the pump by reducing windage and viscous losses which would otherwise exist if inner portion 11 contained coolant and coolant thereby was present in gap “G” between the stator poles and rotor magnets.

Condensate chamber and reservoir 301 comprises a vent hole 302 and drain hole 303. Chamber 301 collects any fluid that may leak past seal 250. Vent 302 and drain 303 are open to ambient.

Thermal potting 12 is used in housing 10 to enrobe stator 200. Thermal potting causes the pump to run cooler by providing a reliable means of heat transfer from the stator and housing. Pump heating typically occurs by iron and copper losses and resistance heating from eddy currents induced in the stator and windings by the varying magnetic field, conduction to the housing from the cooling fluid being pumped, as well as from the engine block (not shown). Thermal potting is known in the electrical arts.

Rotor shaft 100 rotates in a single bearing 120. Bearing 120 may also comprise an integral bearing wherein shaft 100 comprises the bearing inner race. The rotating assembly comprises shaft 100, frame 115, magnets 110 and impeller 150. The single bearing 120 may comprise either a double row ball bearing or double row ball-roller bearing. The roller bearing may comprise cylindrical or tapered rollers. Use of a single bearing is made possible by the short length of the pump shaft afforded by the axial flux motor configuration. The bearings comprise sealed bearings. Due to the short overall length of pump shaft 100, impeller 150 is cantilever mounted to shaft 100.

Coolant flows into impeller intake 151 and is discharged from outlet 152 as the impeller spins. Impellers are known in the water pump arts. Typical operating discharge pressure can be up to approximately 1.5 bar, but may vary to over 5 bar according to the thermal load of the engine. The flow volume may be up to 220 liters per minute, or greater up to 500 lpm depending on the application.

Power electronics are disposed in electronics housing 51 in cover 50. Power electronics control the shaft rotational speed and can also detect faults. Axial flux motor power electronics are known in the art. Cover 50 serves as a heat sink to cool the power electronics. The motor is variable speed which allows the coolant fluid flow to be adjusted according to the thermal load requirements of the engine. The control method comprises PWM, LIN protocol/bus or CAN protocol/bus. A LIN bus is a sub-bus system based on a serial communications protocol. The bus is a single master/multiple slave bus hat uses a single wire to transmit data. Controller Area Network or CAN protocol is a method of communication between various electronic devices like engine management systems, water pumps, oil pumps, active suspension, ABS, gear control, lighting control, air conditioning, airbags, central locking embedded in an automobile. PWM or pulse width modulation is a type of digital signal that is used in a variety of applications including control circuitry.

FIG. 2 is a plan view of the pump. Discharge volute engages with a cooperating channel in an engine block (not shown). Housing 10 is mounted directly to an engine block. The suction or intake side 150 cooperatively engages a fluid conduit (not shown) in the engine.

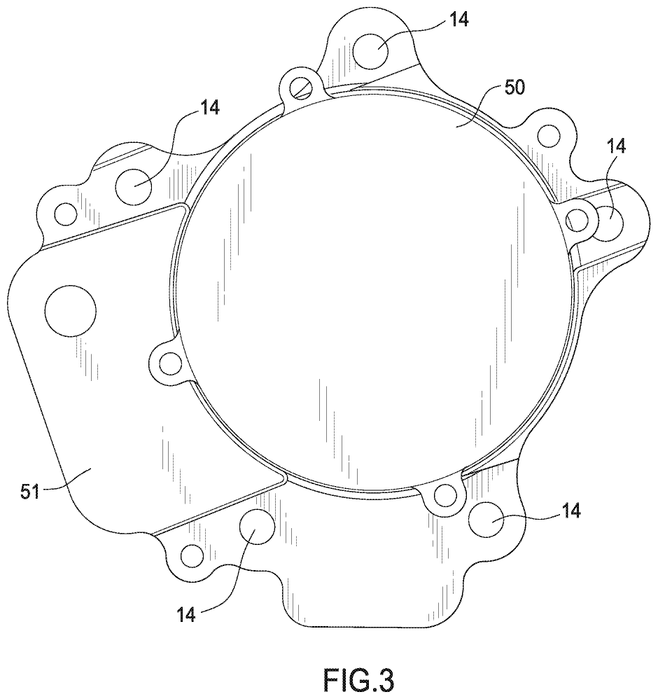

FIG. 3 is a plan view of the pump. Fasteners (not shown) engage mounting holes 14 to attach the pump to a mounting surface such as an engine block (not shown).

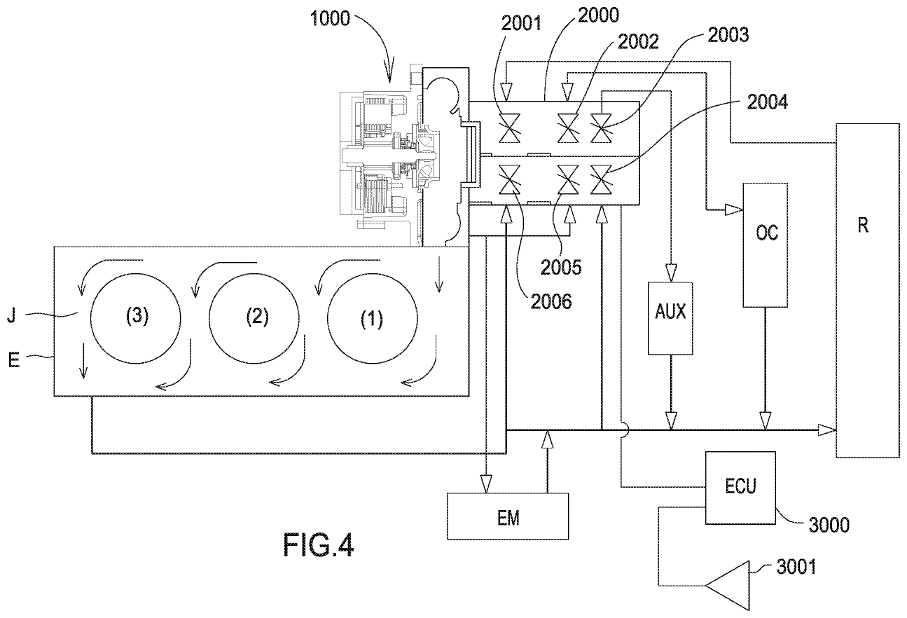

FIG. 4 is a schematic coolant system. Pump 1000 is mounted to an engine (E). Engine (E) comprises three cylinders (1), (2), (3). Engine (E) may comprise any number of cylinders as may be required. Water jacket (J) surrounds the cylinders. The system further comprises a radiator (R), engine transmission oil heat exchanger (OC), auxiliary heat exchanger (AUX), and an exhaust manifold heat exchanger (EM).

A thermal management module 2000 is mounted to the intake side of pump 1000. Module 2000 comprises a plurality of valves 2001, 2002, 2003, 2004, 2005 and 2006. Each valve controls coolant flow for a system component. Valve 2001 controls flow to radiator R. Valve 2002 controls flow to heat exchanger OC. Valve 2003 controls flow to heat exchange AUX. Valve 2004 controls return flow from R, OC, AUX and EM. Valve 2005 controls recirc flow from pump 1000 and flow to EM. Valve 2006 controls return flow from E, EM, AUX, OC and R. The engine ECU through multiple sensors and input signals (3001) detects engine and system condition, ambient conditions and system and driver requests to set each valve in a desired position to regulate coolant flow and thereby control engine and system thermal performance. Each of the valves is in fluid communication with pump intake 151.

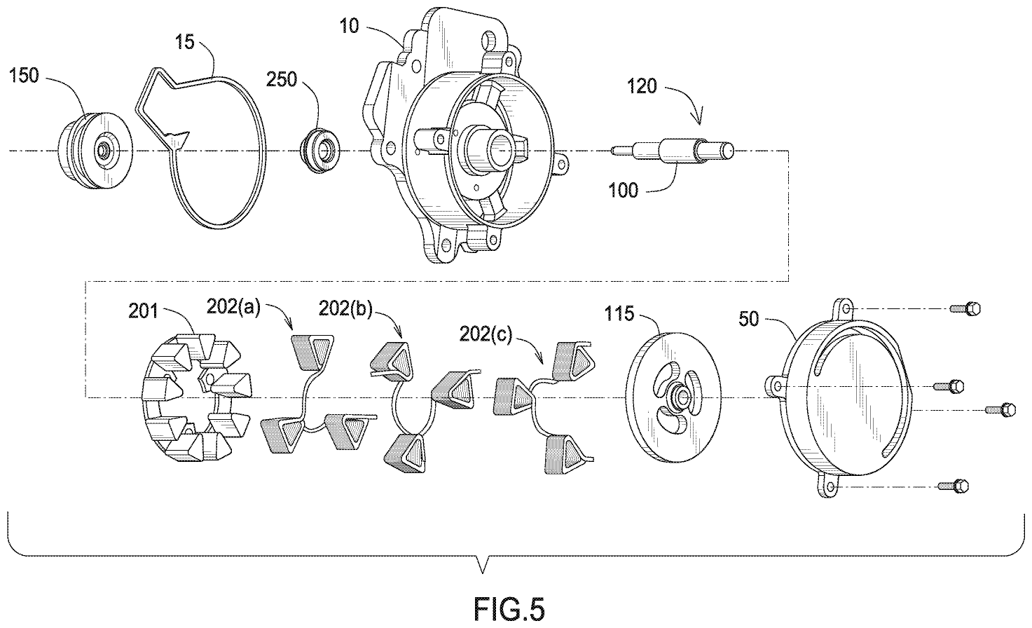

FIG. 5 is an exploded view. The motor is a three phase motor. Windings 202(a) are a first phase. Windings 202(b) are a second phase. Windings 202(c) are a third phase. In this embodiment each phase comprises three stator poles. However, windings for individual poles with connection to single or multiple phases can also be used. A gasket 15 seals between housing 10 and an engine E.

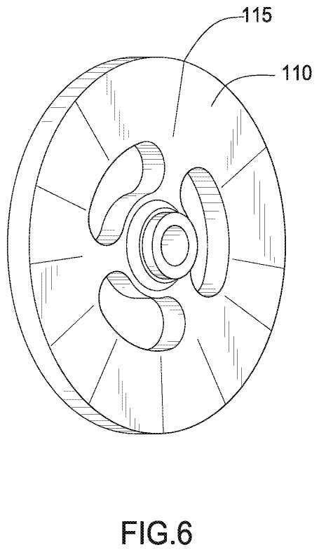

FIG. 6 is a perspective of the rotor magnets and frame. Magnets 220 are mounted to frame 115. Frame 115 is pressed onto shaft 100. Frame 115 may also comprise blades to circulate cooling air.

Magnet 110 may comprise a ring magnet with poles about the circumference, or can comprise a plurality of individual magnets with poles in alternating positions. The magnet may comprise ferrite, rare earth or other known materials. Magnets are attached to the frame using known methods.

Although forms of the invention have been described herein, it will be obvious to those skilled in the art that variations may be made in the construction and relation of parts without departing from the spirit and scope of the invention described herein. Unless otherwise specifically noted, components depicted in the drawings are not drawn to scale. Numeric examples are used to illustrate the invention and are not intended to limit the breadth the claims. Further, it is not intended that any the appended claims or claim elements invoke 35 U.S.C. § 112(f) unless the words “means for” or “step for” are explicitly used in the particular claim. The present disclosure should in no way be limited to the exemplary embodiments or numerical dimensions illustrated in the drawings and described herein.

We claim:

1. An axial flux motor water pump comprising:
a housing;
a cover attached to the housing;
a stator mounted within the housing, the stator comprising a plurality of stator poles mounted in a ring, each stator pole comprising an electric wire winding;
a rotor journalled to the housing in cooperating relation to the stator on a single bearing;
an impeller fixed to an end of the rotor;
a plurality of magnets mounted to an end of the rotor in cooperative relation to the stator poles;
a seal between the rotor and housing whereby the stator and magnets are in a dry zone;
the stator enrobed in thermal potting within the housing; and
power electronics contained in the cover.

2. The axial flux motor water pump as in claim 1, wherein the electric wire winding comprises a flat wire.

3. The axial flux motor water pump as in claim 1, wherein the electric wire winding comprises a round wire.

4. The axial flux motor water pump as in claim 1, wherein the rotor is journalled on a double row ball bearing.

5. The axial flux motor water pump as in claim 1, wherein the impeller is cantilever mounted to the rotor.

6. A water pump comprising:
an axial flux electric motor having a rotor and stator, the rotor journalled with a single bearing and the stator comprising flat wire windings;
an impeller cantilever mounted to an end of the rotor;
a seal on the rotor thereby creating a dry zone within the axial flux electric motor, the stator contained in the dry zone;
thermal potting to enrobe the stator; and
a power electronics circuit for controlling a motor speed contained in a cover.

7. The water pump as in claim 6, wherein the bearing is a double row bearing.

8. The water pump as in claim 7, wherein the double row bearing is a ball bearing.

9. The water pump as in claim 7, wherein the double row bearing is a roller bearing.

10. A cooling system comprising:
an axial flux motor water pump, the axial flux motor water pump configured to emit a first signal to a controller and to receive a second signal from the controller whereby a motor speed is controlled;
a fluid conduit system connected to an axial flux motor water pump inlet and outlet;
a device in the fluid conduit for adjusting a fluid flow from the axial flux motor water pump, the device configured to receive a control signal from the controller.

11. The cooling system as in claim 10, wherein the device comprises a valve.

12. The cooling system as in claim 10, wherein the axial flux motor comprises:
an axial flux electric motor having a rotor and stator, the rotor journalled with a single bearing and the stator comprising flat wire windings;
an impeller cantilever mounted to an end of the rotor;
a seal on the rotor thereby creating a dry zone within the axial flux electric motor, the stator contained in the dry zone;
thermal potting to enrobe the stator; and
a power electronics circuit for controlling a motor speed contained in a cover.

13. The cooling system as in claim 10 further comprising one or more heat exchangers.

14. The cooling system as in claim 13 further comprising one or more valves for controlling a fluid flow through each heat exchanger.

15. The cooling system as in claim 14, wherein each valve is in communication with the controller.
